(19) United States
(12) Patent Application Publication
(10) Pub. No.: US 2013/0275519 A1
(43) Pub. Date: Oct. 17, 2013

(54) SYSTEMS AND METHODS FOR AUTOMATICALLY RESPONDING TO A MESSAGE ABOUT UNVIEWED CONTENT

(71) Applicant: Michael R. Nichols, La Canada-Flintridge, CA (US)

(72) Inventor: Michael R. Nichols, La Canada-Flintridge, CA (US)

(73) Assignee: UNITED VIDEO PROPERTIES, INC., Santa Clara, CA (US)

(21) Appl. No.: 13/446,710

(22) Filed: Apr. 13, 2012

(51) Int. Cl. G06F 15/16

(52) U.S. Cl. 709/206

(57) ABSTRACT

Embodiments provide methods and systems for automatically generating a response to a message related to unviewed content. In some embodiments, a user sends a message that relates to a particular media asset to another user. A server that receives the message from the sender identifies the media asset to which the message relates. The server also maintains or accesses a viewing history that identifies media assets that the recipient has viewed. The server cross-references the identity of the media asset with the viewing history to determine whether the recipient has viewed the media asset. If the recipient has not viewed the media asset, the server refrains from transmitting the message to the recipient, and the server automatically generates a response to the sender of the message indicating that the recipient has not seen the media asset.

### BACKGROUND

With increased consumer use of computers, smartphones, televisions, and other consumer electronic user devices, users of electronic devices increasingly have round-the-clock access to messages and updates from their friends and family. For example, people commonly check their email, access social network feeds, read mobile phone messages, and access news feeds throughout the day, and may receive instantaneous updates from these sources from their computers and mobile devices.

Computers, televisions, and mobile devices are also giving users increased control over when they view electronic content. For example, users can record broadcast television programs using, for example, a DVR, allowing them to view television programs after they have been broadcast. Users also have increased access to on-demand programming received from on-demand content providers or websites such as HULU or NETFLIX. With increased flexibility in viewing time, two viewers often do not view content at the same time (e.g., when the program is originally broadcast). In addition, if two viewers are in different time zones or access content through different content providers, some content may be broadcast to or made available to the viewers at different times; this also may cause the viewers to view content at different times.

If one viewer plans to watch a program after one of his contacts has already viewed it, he may still receive messages or view posts from his contact in the intervening time period. The messages or posts may divulge information related to the program, such as a final score in a sports game or a plot twist in a drama, which would make the viewing experience less enjoyable for a viewer who inadvertently reads a message or post before the program. These types of messages are commonly referred to as “spoilers”.

### SUMMARY

In order to prevent a user from seeing a message about a media asset before the user has a chance to view the media asset, systems and methods are provided herein for automatically generating and transmitting a response to a message that relates to an unviewed media asset. By automatically identifying a message that relates to content that a message recipient has not seen, preventing the message from being displayed to the recipient, and automatically responding to the sender, a user can reduce the risk of learning outcomes or plot developments in media assets before he views the media assets.

In some embodiments, a user sends a message that relates to a particular media asset to another user. A server that receives the message from the sender identifies the media asset to which the message relates. The server also maintains or accesses a viewing history that identifies media assets that the recipient has viewed. The server cross-references the identity of the media asset with the viewing history to determine whether the media asset is in the recipient's viewing history, which means that the recipient has viewed the media asset. If the recipient has viewed the media asset, the server transmits the message to a user device of the recipient for display. If the recipient has not viewed the media asset, the server refrains from transmitting the message to the recipient, and the server automatically generates a response to the sender of the message indicating that the recipient has not viewed the media asset.

In some embodiments, the server monitors the recipient's viewing history to determine when the recipient has viewed the identified media asset. Once the recipient has viewed the identified media asset, the server may allow the recipient to view the message, which may involve sending the message to a user equipment device of the recipient and displaying the message on the user equipment device. The server may also indicate to the sender of the message that the recipient has viewed the media asset and/or the message.

If the recipient has scheduled a time to view the media asset, the response may include an indication of the date or time at which the recipient has scheduled to view the media asset. If the recipient does not have access the media asset, the response may include an identification of the date or time at which the media asset will become available to the recipient.

The server may transmit to the recipient a notification indicating that a message has been blocked. The notification may include an identification of the media asset to which the message relates and/or an identification of the message sender. The recipient may be able to override the message block and request to view the message before viewing the media asset to which it relates. In this case, the server may send a notification to the sender indicating that the message was viewed.

If the server receives a second message from the same sender relating to the same media asset, the server may determine that a response indicating that the recipient has not seen the media asset has already been transmitted to the sender. The server may refrain from sending a second response to the sender in this case.

In some embodiments, the blocking and automatic response functions are not performed by a server, and the message is transmitted to the recipient's user device. In such embodiments, the recipient's user device may perform functions similar to the functions of the server described above.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings and other media guidance information in accordance with an embodiment of the invention;

FIG. 2 shows another illustrative display screen that may be used to provide media guidance application listings in accordance with an embodiment of the invention;

FIG. 3 is a block diagram of an illustrative user equipment device in accordance with an embodiment of the invention;

FIG. 4 is a block diagram of an illustrative interactive media system in accordance with an embodiment of the invention;

FIG. 5 is an illustrative data structure of a user's viewing history and viewing schedule in accordance with an embodiment of the invention;

FIG. 6 is a block diagram of a system for automatically replying to a message about unviewed content in accordance with an embodiment of the invention;

FIG. 7 is a block diagram of an alternative system for automatically replying to a message about unviewed content in accordance with an embodiment of the invention;

FIG. 8 is an illustrative display screen for allowing a user to enter a message related to a media asset in accordance with an embodiment of the invention;

FIG. 9 is an illustrative display screen for receiving a message related to a media asset and an identification of the media asset in accordance with an embodiment of the invention;

FIG. 10 is an illustrative display screen for receiving a selection of a particular media asset that the message of FIG. 9 is related to in accordance with an embodiment of the invention;

FIG. 11 is an illustrative display screen for displaying a suggestion of a media asset that a message may be related to in accordance with an embodiment of the invention;

FIG. 12 is an illustrative display screen for displaying selectable options for delivering a message related to an unviewed media asset in accordance with an embodiment of the invention;

FIG. 13 is an illustrative display screen for displaying an automatically generated response to a sent message in accordance with an embodiment of the invention;

FIG. 14 is an illustrative display screen for displaying a spoiler alert for a message that relates to a media asset that the recipient has not viewed in accordance with an embodiment of the invention;

FIG. 15 is an illustrative display screen for displaying a recorded content list that alerts a user to received messages related to recorded content in accordance with an embodiment of the invention;

FIG. 16 is an illustrative display screen for displaying message blocking options and receiving message blocking settings in accordance with an embodiment of the invention;

FIG. 17 is an illustrative display screen for displaying additional message blocking options and receiving additional message blocking settings in accordance with an embodiment of the invention;

FIG. 18 shows an illustrative process for sending an automatic response to a message related to a media asset that has not been viewed by a recipient and sending the message to the recipient after he has viewed the media asset in accordance with an embodiment of the invention; and

FIG. 19 shows an illustrative process for setting up blocking criteria, blocking a message, sending an automatic response to a blocked message, and sending the message after it has been unblocked in accordance with an embodiment of the invention.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” or “media asset” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

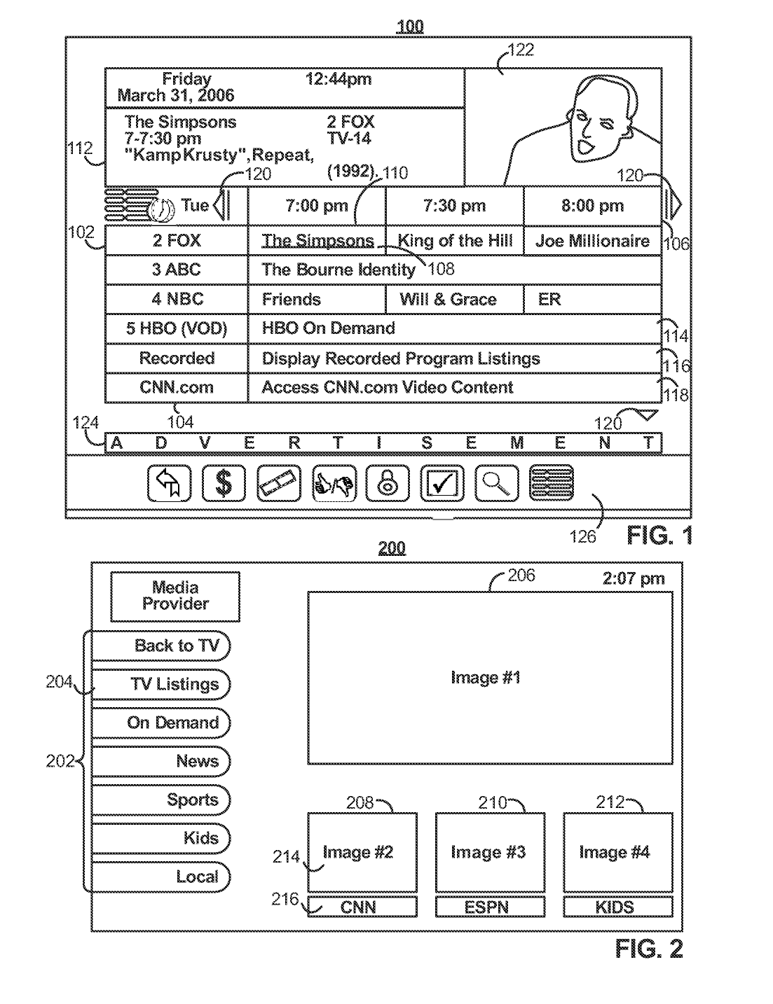

FIGS. 1-2 show illustrative display screens that may be used to provide media guidance data. The display screens shown in FIGS. 1-2 and 5-16 may be implemented on any suitable user equipment device or platform. While the displays of FIGS. 1-2 and 5-16 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, from a social network profile associated with the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

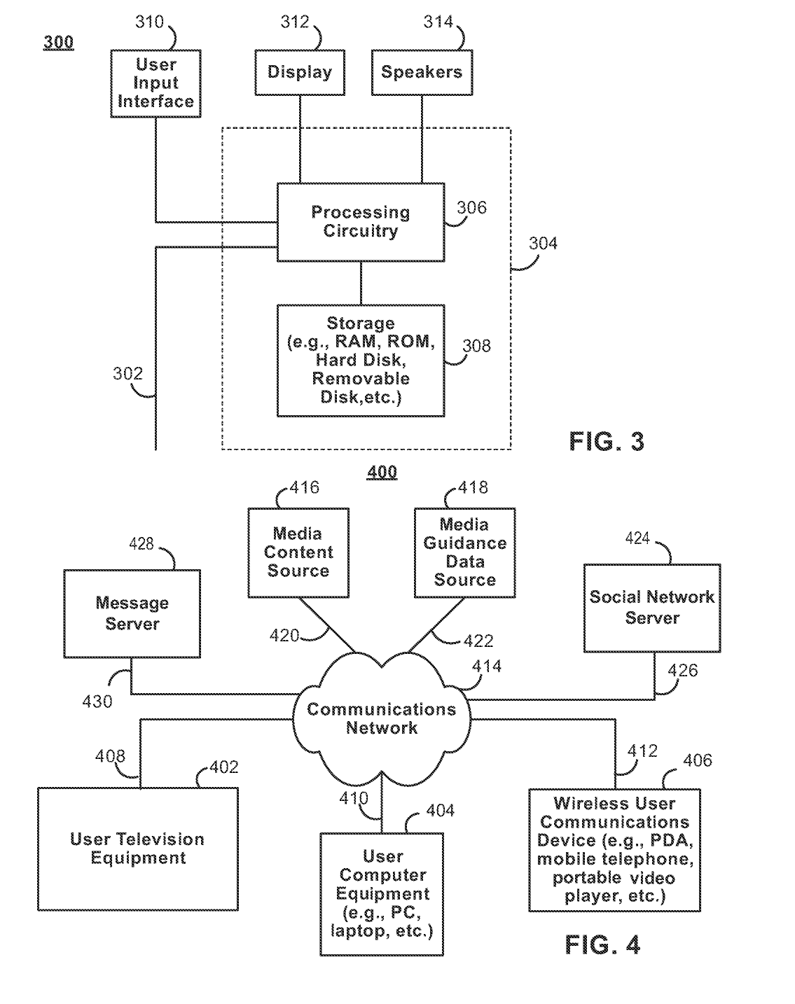

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, social network server 424, and messaging server 428, each which is coupled to communications network 414 via communication paths 420, 422, 426, or 430, respectively. Paths 420, 422, 426, and 430 may include any of the communication paths described above in connection with paths 408, 410, and 412. Communications with the content source 416, media guidance data source 418, social network server 424, and messaging server 428 may be exchanged over one or more communications paths, but are each shown as a single path in FIG. 4 to avoid overcomplicating the drawing. In addition, there may be more than one of each of content source 416, media guidance data source 418, social network server 424, and messaging server 428 but only one of each is shown in FIG. 4 to avoid overcomplicating the drawing. (The different types of each of these sources are discussed below.) If desired, content source 416, media guidance data source 418, social network server 424, and/or messaging server 428 may be integrated as one device or multiple devices. Although communications between sources 416 and 418, servers 424 and 428, and user equipment devices 402, 404, and 406 are shown as through communications network 414, in some embodiments, sources 416 and 418 and servers 424 and 428 may communicate directly with user equipment devices 402, 404, and 406 via communication paths (not shown) such as those described above in connection with paths 408, 410, and 412.

Social network server 424 may store data related to the users of the social network. In addition, social network server 424 may store any information, messages, or other content entered or uploaded by users of the social network. Social network server 424 may be in communication with one or more databases or data stores (not shown) for storing social network data or content. Social network server 424 may also perform processing functions for the social network, such as receiving, generating, and transmitting messages and/or posts to and from users, and social network server 424 may store instructions for performing these or other functions. In some embodiments, a social network may be implemented as a cloud-based service, as discussed below.

Messaging server 428 may implement a messaging feature between users of user equipment devices 402, 404, and/or 406. Messaging server 428 may contain communications circuitry configured to receive and transmit messages over communications network 414. Messaging server 428 may also contain processing circuitry configured for performing routing functions, message encryption, message transformation or reformatting, or other processing features. Messaging server 428 may receive availability information from user equipment devices 402, 404, and 406 or query user equipment devices 402, 404, and 406 to determine when to transmit messaging that have been received. Messaging server 428 may contain a database or data store for storing information related to users, such as contact information, delivery information, preferences, privacy settings, passwords, etc. Messaging server 428 may also store messages and files attached to messages. In some embodiments, messaging server 428 may generate messages, such as automatically generated responses described below, and transmit these messages to one or more users. Messaging server 428 is described in greater detail with respect to FIG. 6.

Messaging server 428 may be, for example, an SMTP server, a POP3 server, an SMS center, and EMS center, an MMS center, and instant messaging server, or any other server or other device for sending and receiving messages. Messaging server 428 may be an application server or a web server that hosts an application or website that includes a messaging feature. Messaging server 428 may user push technology or pull technology for delivering messages. In some embodiments, messaging server 428 may be a social network server, such as social network server 424, which receives and transmits messages between users of the social network, and, in some embodiments, automatically generates messages or responses to users of the social network.

In some embodiments, messaging server 428 may be in communication with a database containing users' viewing histories, which identify content that has been viewed by each user. Viewing histories may be maintained by a content source, such as content source 416 described below. In other embodiments, messaging server 428 may maintain users' viewing histories, e.g., if messaging server 428 is a web server of an Internet content provider that provides a messaging feature. In some embodiments, messaging server 428 may encompass multiple devices, which may be in communication with each other.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

With the growing popularity of social networks, such as Facebook™, MySpace™, and Twitter™, users have limitless potential to share ideas, activities, events, and interests. A social network service essentially consists of a representation of each user (e.g., a user profile), his social links, and a variety of additional services. A user may communicate with the social network through user equipment device 300, described above in relation to FIG. 3.

The user may communicate with the social network via a website accessed by a web browser running on user equipment device 300. Alternatively, the user may communicate with the social network via a widget on user equipment device 300. Widgets are software programs that provide information from the Internet to a user through web services. The widget may be an application that is downloaded or installed on user equipment device 300, and the widget may be run by an interpreter or virtual machine run by control circuitry 304 of user equipment device 300. The widget may allow the user to interact with web services while viewing social media content on user equipment device 300. The widget may have the same layout on the various types of user equipment devices, or the layout may be tailored to the display capabilities of each user equipment device. In some embodiments, the widget may be an applet.

User equipment devices 300, such as user television equipment 402, user computer equipment 404, and wireless user communications devices 406, may send data to and receive data from the social network via communications network 414. Data related to the users of the social network may be stored on one or more social network servers 424. In addition, any information or content entered or uploaded by users of the social network may be stored on social network server 424. Media content available via the social network may be stored on media content source 416 and accessed by the user equipment devices 300 directly from media content source 416 or via social network server 424. In some embodiments, the social network may be implemented as a cloud-based service, as discussed above.

Users of a social network may include individuals or other entities, such as sports teams, performing artists, bands, television programs, magazines, books, companies, products, brands, charities, institutions, etc. Users may maintain connections to other individual users and/or entities in the social network. As referred to herein, the term “social network contact” should be understood to mean a relationship between two or more users of the social network. A contact may be created when a user designates another user as a friend, follower, subscriber, buddy, etc., or when a user indicates that he has an interest in or “likes” another user. A social network contact may be created when a user designates another user as being in a circle or group, or when a user designates himself as being in a circle or group. A social network contact may be created by a designation or other action by a single user, or it may require action by two or more users. A social network contact may be created using any other means of associating two or more users on a social network. Data identifying social network contacts may be stored by social network server 424.

The user of a social network may post social network content to his user profile or another user's user profile, or send and receive social network content from other users through the social network. As referred to herein, the term “social network content” should be understood to mean any electronically viewable content, such as text, links to websites, video clips, audio, pictures, television programming, pay-per-view programming, on-demand programs (as in video-on-demand (VOD) systems), Internet content (e.g., streaming content, downloadable content, Webcasts, etc.), content information, rotating images, documents, playlists, websites, articles, books, electronic books, blog entries, advertisements, chat sessions, applications, games, reactions to social network content (e.g., likes, dislikes, comments, shares, ratings, etc.) and/or any other media or multimedia and/or combination of the same. In some embodiments, some social network content may describe or otherwise relate to other content, such as a television program or movie.

A user of a social network may post social network content to, for example, his user profile, another user profile, a group profile, or any other page on a social network. The post may be visible to all users of the social network or who can access the social network. Alternatively, the post may be visible to only one user or a select group of users. For example, a user may post social network content so that it is visible to a specified set or circle of social network contacts, all of his social network contacts, second-order social network contacts (i.e., social network contacts of his social network contacts), or nth-order social network contacts. If a user posts content to a social network contact's profile or a group profile, the content visibility may be based upon visibility settings of the social network contact or group. For example, if a user posts content to a social network contact's profile, the content may be visible to all of the social network contact's social network contacts, even if some of these second order social network contacts are not the user's social network contacts. If a user posts content to a group, the content may be visible to all members of the group.

In some embodiments, if the social network content relates to a media asset the visibility of the post may also be conditioned on which contacts or users have viewed the media asset. For example, if a user posts social network content relating to a particular media asset that would ordinarily be visible to all contacts, the social network may determine which contacts have viewed the media asset and make the post visible only to these contacts. In other embodiments, the social network content may determine which contacts have planned or scheduled to view the media asset, and not make the post visible to these contacts, but make it visible to other contacts. Visibility settings may be specified by the posting user and/or one or more of the contacts.

Social network content may be stored on social network servers 424 and/or media content source 416. A user may generate social network content by, e.g., entering text, uploading a file, interacting with the social network, interacting with an application within the social network, interacting with an application or web page outside the social network, or adding a link. The social network can thus receive social network content by, e.g., receiving entered text, receiving an uploaded file, receiving user commands, receiving data from applications within or outside the social network, receiving data from web sites, or receiving links.

Social network content can be promulgated across the network by its users. When a first user adds social network content to the social network, the social network content may be visible to one or more users of the social network. After a first user has made social network content available to a certain set of social network users (e.g., the first user's social network contacts), a second user to whom the social network content is visible can make the social network content available to a different set of social network users (e.g., the second user's social network contacts). The second user can make the social network content available by, for example, reposting the social network content, sending a message containing the social network content, posting a link to the content, reacting to the social network content (e.g., liking, disliking, rating, or commenting on the content), or interacting with the social network content in some other way.

In addition to social network content input by users, social network content may include content from cable sources, satellite content providers, on-demand content providers, Internet content providers, local or remote media servers, or other providers of media content. A social network content source may provide media such as audio and video clips, program episodes, advertisements, blooper reels, cast interviews, promotional trailers, and online links to any of the above types of media. In some embodiments, social network server 424 or another social network content source, such as media content source 416 or one or more user equipment devices 300, may automatically identify and/or provide social network content or content recommendations to a user based on the user's activities on the social network, or a user of the social network may provide social network content recommendations to one or more other users, as described in greater detail in Ketkar, U.S. Patent Application Publication No. 2012/0030587, filed Jul. 30, 2010, which is incorporated herein by reference.

In some embodiments, a server may automatically generate a response to a message related to content that the message's intended recipient has not viewed. The message may be transmitted over a social network, such as the social network described above; email; a media guidance application; a website; over a mobile phone or mobile device networks; or through any other network or other mechanism for receiving and transmitting messages between users. The server may maintain or access a viewing history identifying media assets that the recipient of the message has previously viewed. Communications circuitry of the server may receive a message from a sender to be delivered to a recipient user. The message may relate to a particular media asset. Control circuitry of the server may identify the media asset to which the media asset is related. The control circuitry then may cross-reference the identified media asset to the recipient's viewing history to determine whether the recipient has viewed the media asset. If the recipient has not viewed the media asset, the server refrains from transmitting or causing the message to be displayed to the recipient, and automatically generates and transmits a response to the sender of the message indicating that the recipient has not seen the media asset.

As described herein, the server is messaging server 428, but in other embodiments, the server may alternatively be social network server 424 or another device with messaging functionality that is similar to the functionality of messaging server 428. For example, content source 416 may include the automatic message blocking and response feature described herein in relation to messaging server 428. In other embodiments, described in greater detail herein, some or all of the automatic response generation and transmission may alternatively be performed by a user equipment device receiving the message, such as user equipment device 300.

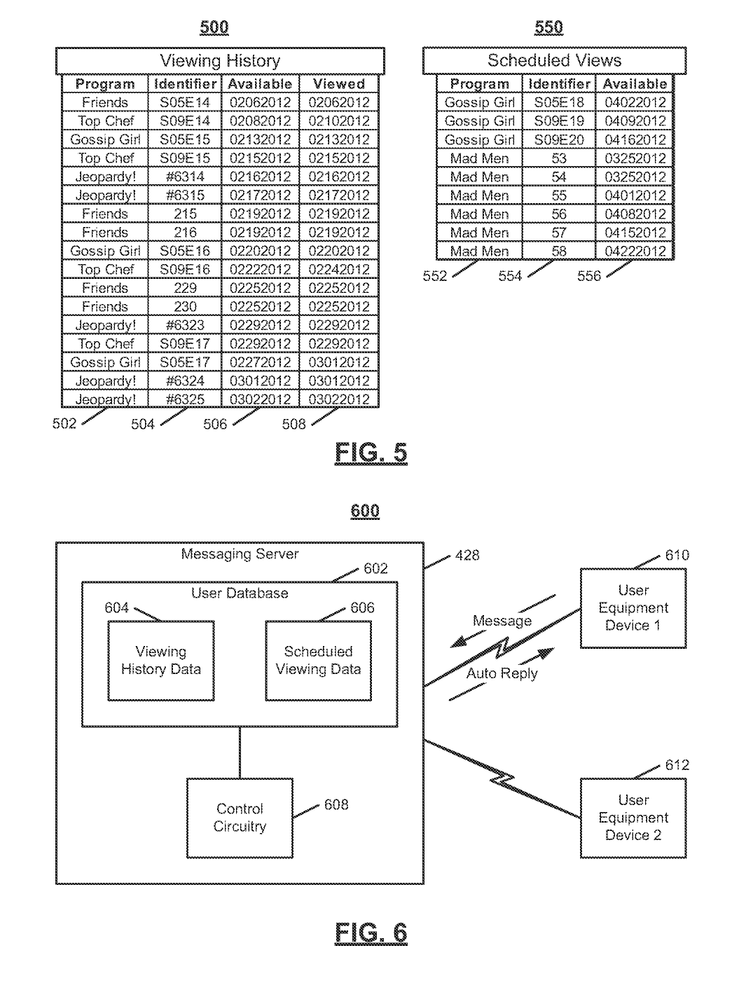

To determine whether a recipient of a message that is related to a particular media asset has viewed the media asset, messaging server 428 maintains or accesses a viewing history of the recipient user. An exemplary viewing history 500 is shown in FIG. 5. Viewing history 500 identifies media assets viewed by the user by, for example, program name 502 and identifier 504. Identifier 504 may be the season number and episode number within the season, as shown in the identifier 504 column for the television programs Top Chef and Gossip Girl in FIG. 5. Identifier 504 may alternatively be the episode number if all episodes are numbered sequentially, without taking the season into account; this is the format shown for television programs Friends and Jeopardy! Any other type identifier may be shown. In some embodiments, a single identifier that uniquely identifies the media asset may be used in addition to or in lieu of the program name 502 and identifier 504.

Viewing history 500 also may indicate the date that the media asset was initially made available to the user 506 (e.g., the media asset's original air date or the date the media asset was made accessible by an on-demand content provider) and/or the date that the media asset was viewed or accessed by the user 508. The available date 506 and/or viewed date 508 may also indicate the time that the media asset became available and/or was viewed, respectively. If the viewer accesses the media asset multiple times, the viewing history 500 may identify some or all of time(s) that the media asset was accessed, the portion(s) of the media asset that were viewed, and when the user finished viewing the media asset. As shown in FIG. 5, some of the media assets in the viewing history were viewed after they became available, such as the program Top Chef S09E14 and Top Chef S09E16.

Viewing history 500 may contain media assets viewed on one or more user devices. For example, if a user accesses a content provider on more than one user equipment device 300, the Internet content provider may associate each user equipment device 300 with the user. For example, a user may sign onto an Internet content provider's website, widget, or application, and any media asset viewed by the user identified by the sign-on information will be added to that user's viewing history. In another example, if a user has multiple televisions in his house, a television content provider may include media assets viewed on any of the televisions in the household's viewing history. If a household has multiple residents, the content provider may maintain a separate viewing history for each of the residents.

Viewing history 500 may contain media assets accessed though any content source 416, types of which are described above. Viewing history 500 may also contain different types of media assets. For example, a viewing history associated with an Internet content source, such as Hulu, may include video clips, audio clips, episodes of television programs, and/or movies. Viewing history 500 may update automatically based on a user's interaction with a content source.

In some embodiments, viewing history 500 may contain media assets accessed through more than one content source 416. In such embodiments, user equipment device 300, content source 416, messaging server 428, or another device may receive data identifying media assets accessed through multiple content sources and maintain a combined viewing history. For example, if a user accesses media assets through multiple content sources 416 (e.g., an Internet content provider and a broadcast content provider), the individual content sources may maintain independent viewing histories for that user. Alternatively or additionally, multiple individual user equipment devices 300 that a user uses to access media assets may maintain independent viewing histories of media assets accessed on the user equipment devices 300. Then, one or more of the user's user equipment devices 300 or the messaging server 428 may receive data from these individual viewing histories stored by the media content sources 416 and/or the individual user devices 300 and create a combined viewing history of media assets accessed through all of the content sources 416 and/or all of the user equipment devices 300.

In some embodiments, a user may manually input media assets to add to his viewing history, such as movies he has seen in the theater or programs he has viewed on a friend's television. User device 300 may provide a user interface for receiving a user selection of one or more media assets to add to viewing history 500. In some embodiments, if a user is watching a media asset on a friend's user equipment device 300, the friend may be able to enter information identifying the user so that the media asset can be added to the user's viewing history 500.

In addition to viewing history 500, a content source 416, user equipment device 300, messaging server 428, or other device may maintain a viewing schedule 550 for a user. Viewing schedule 550 includes a list of media assets that a user intends to view in the future, and may further include the time that the user intends to view each media asset. In FIG. 5, the media assets are identified by program name 552 and identifier 554, which are similar to program name 502 and identifier 504. Any other type identifier may be shown. In some embodiments, a single identifier that uniquely identifies the media asset may be used in addition to or in lieu of the program name 502 and identifier 504.

Viewing schedule 550 also includes the date 556, and in some embodiments the time (not shown), when each of the media assets becomes available to the user (e.g., the media asset's air date or the date the media asset will be made accessible by an on-demand content provider). If the user does not intend to view a media asset immediately when it becomes available, viewing schedule 550 may also include a time at which the user has scheduled to view the media asset.

FIG. 6 shows a system 600 for receiving a message from a first user equipment device and automatically sending a response to the message if the message relates to a media asset that the message's intended recipient has not viewed. System 600 includes messaging server 428 and two user equipment devices 610 and 612. User equipment devices 610 and 612 may be similar to user equipment device 300. User equipment devices 610 and 612 are in communication with messaging server 428 over two communications links, which may be similar to the communications links of communications network 414, described above. Messaging server 428 includes user database 602, which contains data related to at least the user of the second user equipment device 612, and control circuitry 608. Control circuitry 608 may execute instructions stored on messaging server 428 for performing the functions described herein. User database 602 contains viewing history data 604, which may contain the type of data shown in viewing history 500 described in relation to FIG. 5, and scheduled viewing data 606, which may contain the type of data shown in viewing schedule 550 described in relation to FIG. 5. Control circuitry 608 is in communication with and can access data from user database 602.

The first user equipment device 610 sends a message to messaging server 424; the message may identify a user of the second user equipment device 612 as the message's recipient. Upon receipt of this message, the control circuitry 608 may determine a media asset that the message relates to. The media asset may be identified by data transmitted with the message and received by control circuitry 608, or control circuitry 608 may analyze the content of the message to determine a media asset to which the message relates. In some embodiments, messaging server 428 may request additional information from the first user equipment device 610 to identify the media asset. Methods for determining the media asset to which the message relates are described in greater detail in relation to FIG. 8 through FIG. 11.

Once control circuitry 608 has identified the media asset to which the message relates, control circuitry 608 compares the identified media asset to viewing history data 604 of a user of the second user equipment device 612, i.e., the intended recipient of the message. If control circuitry 608 determines that the intended recipient has viewed the media asset, messaging server 428 transmits the message to user equipment device 612 for display (message transmission not shown).

If control circuitry 608 determines that the intended recipient has not viewed the media asset, messaging server 428 generates an automated response to the message, which is sent to the first user equipment device 610. The automated response indicates that the message has not been sent to the intended recipient because the intended recipient has not viewed the media asset. In some embodiments, control circuitry 608 determines when the intended recipient has viewed the media asset or a portion of the media asset, and at this point forwards the message to the second user equipment device 612.

In some embodiments, control circuitry 608 references the scheduled viewing data 606 to identify the time at which the intended recipient has scheduled to view the media asset, and control circuitry 608 includes the scheduled viewing time in the automated reply. In some embodiments, the media asset may not yet be accessible by the second user equipment device 612, e.g., because the second user equipment device 612 is in a different time zone from the first user equipment device 610, because the second user equipment device 612 is in a different country from the first user equipment device 610, or because the second user equipment device 612 receives the media asset from a content provider that is different from the content provider of the first user equipment device 610. In this case, the response may include an identification of the date and/or time at which the media asset will become accessible by the second user equipment device 612.

If messaging server 428 receives a second message from the user of the first user equipment device 610 relating to the same media asset before the user of the second user equipment device 612 has viewed the media asset, control circuitry 608 may determine that a response indicating that the second user has not viewed the media asset has already been generated and transmitted to the first user equipment device 610. The messaging server 428 may refrain from generating and transmitting a second response in this case. To determine whether any responses have been sent, messaging server 428 may maintain a record of the responses that have been sent, with the record for each response containing, for example, information identifying the user of the first user equipment device 610, the user of the second user equipment device 612, and the media asset about which the response was sent.

In some embodiments, the message is a post in a social network for display to a set of users of the social network, such as the social network contacts of the user writing the post. In such embodiments, messaging server 428 may be a social network server such as social network server 424, and messaging server 428 may cross-reference the media asset to which the post relates to the viewing history of each of the contacts to whom the post would be visible. If message server 428 determines that a contact has not viewed the media asset, messaging server 428 hides this post from the contact until the contact has viewed the media asset or a portion of the media asset.

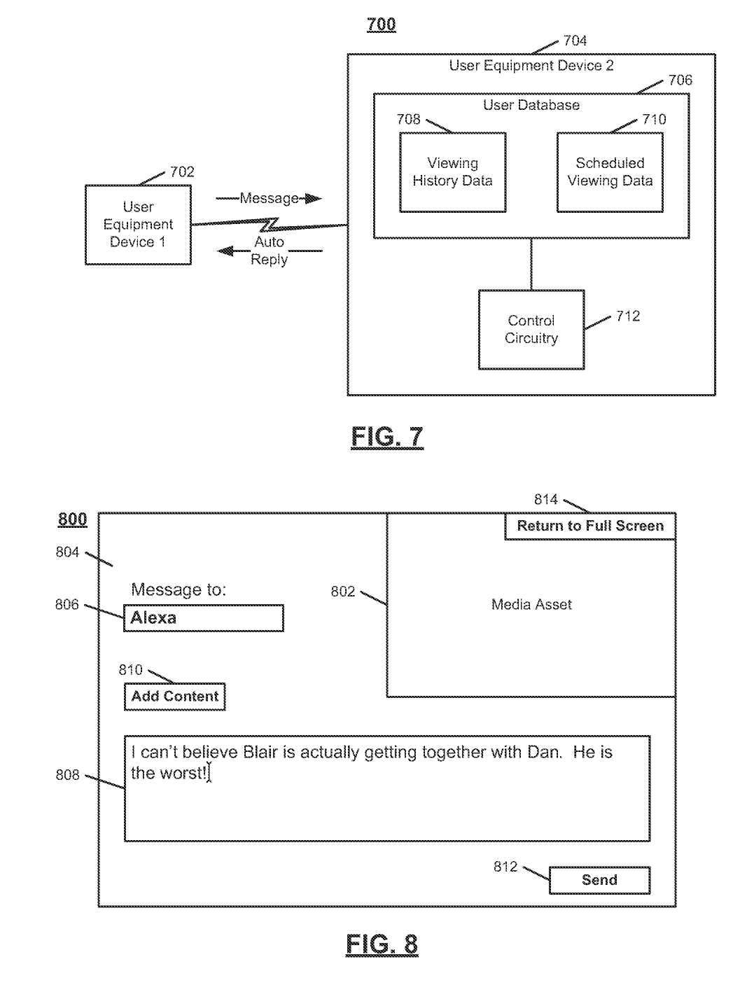

FIG. 7 shows an alternative system 700 for receiving a message from a first user equipment device and automatically sending a response to a message related to content that the message's intended recipient has not viewed. In system 700, the user equipment device 704 receiving the message generates the reply and prevents a user of user equipment device 704 from viewing the message until the user has viewed the media asset. Thus, in system 700, a user equipment device rather than a central server, as in system 600, performs the handling of the received message.

System 700 includes a first user device 702 that sends a message to a second user device 704. User equipment devices 702 and 704 may each be similar to user equipment device 300. The second user device 704 includes a user database 706, which may contain user data, such as viewing history data 708 and scheduled viewing data 710, that is related to one or more users of user device 704. Viewing history data 708 may be similar to viewing history data 500 described in relation to FIG. 5, and scheduled viewing data 710 may be similar to viewing schedule data 550 described in relation to FIG. 5. Viewing history data 708 may include media assets that have been displayed by user equipment device 704, and viewing history data 708 may further include media assets displayed by one or more other user equipment devices of the user or viewed by the user elsewhere, such as in a movie theater. Similarly, scheduled viewing data 710 may include media assets that are scheduled to be displayed by user equipment device 704, and scheduled viewing data 710 may further include media assets that the user intends to watch on other user equipment devices of the user or elsewhere. Control circuitry 712 may execute instructions stored on user device 704 for performing the functions described herein. Control circuitry 712 is in communication with and can access data from user database 706.

Upon receipt of the message from user device 702 to user device 704, control circuitry 712 determines a media asset that the message relates to in a similar manner to control circuitry 608 described above. Control circuitry 712 then compares the identified media asset to viewing history data 708. If control circuitry 712 determines that the user has viewed the media asset, control circuitry 712 makes the message available to the user through a user interface of user equipment device 704.

If control circuitry 712 determines that the intended recipient has not viewed the media asset, control circuitry 712 generates an automated response to the message to be sent to the first user equipment device 702. The automated response indicates that the message has not been sent to the intended recipient because the intended recipient has not viewed the media asset. In some embodiments, control circuitry 712 determines when the intended recipient has viewed the media asset or a portion of the media asset, and at this point makes the message available to the user through a user interface of the user equipment device 704.

In some embodiments, control circuitry 712 references the scheduled viewing data 710 to identify the time at which the receiving user plans to view the media asset and includes the scheduled viewing time in the automated response. In some embodiments, the media asset may not yet be accessible by the second user equipment device 704, e.g., because the second user equipment device 704 is in a different time zone from the first user equipment device 702, because the second user equipment device 704 is in a different country from the first user equipment device 702, or because the second user equipment device 704 receives the media asset from a content provider that is different from the content provider of the first user equipment device 702. In this case, the response may include an identification of the date or time at which the media asset will become accessible by the second user equipment device 704.

Various processes for sending a message, identifying a media asset to which the message relates, receiving an automated response message, receiving an indication that one or more blocked messages have been sent, and setting up a message blocker are illustrated in further detail by the display screens shown in FIGS. 8 through 17. The display screens may be displayed on user equipment such as user equipment device 300. An application stored on user equipment device 300 or a remote application may instruct control circuitry 304 of user equipment device 300 to display, using display 312, display screens such as those depicted in FIGS. 8 through 17. The application may contain instructions for receiving user input, displaying output, and performing other functions described herein.

FIG. 8 is an illustrative display screen 800 showing a message entered by a user to be sent to an identified contact. Display screen 800 may be a display screen of a content provider and may include a media asset 802 in the upper right hand corner that is displayed to the user. The display screen 800 may also include message input interface 804 for displaying a message being entered by the user to transmit to another user. User input interface 310 may provide user controls of the media asset, such as play, pause, stop, fast forward, and rewind controls. User input interface 310 may able to receive a command from the user to toggle the view of the media asset 802 to a larger size or to full screen, e.g., by receiving a user selection of Return to Full Screen Button 814. This may cause control circuitry 300 to shrink the message input interface 804, remove the message input interface 804 from the display 800, or display the message input interface 804 as an overlay over the media asset 802. In some embodiments, the display screen 800 may not include a media asset 802, and the display screen 800 may include other elements not shown in FIG. 8.

Message input interface 804 may include a recipient entry region 806 for receiving user input identifying one or more recipients of the message. The recipient(s) may be identified by name, username, email address, telephone number, and/or any other suitable identifier. Message input interface 804 also may include a message entry region 808. To write a message, a user may type a message into message entry region 808 using user input interface 310. The message is received by the processing circuitry 306 and may be temporarily stored to storage 308 or sent to and stored by messaging server 428 as it is being entered.

Message input interface 804 may further include Add Content button 810. To add content, such as a media asset, to the post, the user selects the Add Content button 810. In some embodiments, receiving a selection of the Add Content button 810 may cause control circuitry 304 to insert the media asset currently being viewed into the message or to attach the media asset to the message. Alternatively, upon receiving a selection of the Add Content button 810, control circuitry 304 may display an upload menu with which a user can specify a path to a file containing the content he wishes to upload or a link to a website containing the content he wishes to upload. Upon receiving a path to a location on user equipment device 300, control circuitry 304 accesses the specified content and uploads it to messaging server 428. Upon receiving a link to a website containing the content, control circuitry 304 may access the website and download the content, or control circuitry 304 may send the link to messaging server 424 to access the content. Content may be added to the message using an alternative upload mechanism, e.g., by dragging and dropping a file containing the content into the message entry region 808.

Once the user has finished entering the text of the message and any other content, he selects the Send button 812. Upon receiving a selection of the Send button 812, control circuitry 304 sends the text entered into the text entry region 808 and any added content to either a messaging server 428 (as discussed in relation to system 600) or directly to the recipient identified in recipient entry region 806 (as discussed in relation to system 700).

The messaging server 428 or receiving user equipment device 704 (both of which are referred to herein as the “message receiving device”) then identifies the media asset that the message relates to. For example, if a user sends the message while viewing a media asset, the message may be accompanied by information identifying the media asset being viewed by the sender, and control circuitry 608 or 712 may identify that media asset as the media asset to which the message relates.

In another example, the receiving device analyzes the text of the message to determine which media asset the message relates to. The receiving device may use a computerized predictive model that uses the text of the message, which may include names of characters, locations, events, etc., to output one or more media assets that the message likely relates to. For example, the message in FIG. 8 mentions “Blair” and “Dan”, which are the names of two main characters of the television show Gossip Girl. Based on these character names, the computerized predictive model may identify that the media asset discussed is an episode of Gossip Girl. Based on the event described (in this example, Blair getting together with Dan), the computerized predictive model may identify the particular episode that the message relates to.

In still another example, if the message includes content or a link to content, control circuitry 608 or 712 may identify the media asset based on the content. For example, if the content is a clip of an episode of a television program, control circuitry 608 or 712 may identify the episode that the content is from as the media asset to which the message relates. Or, if the message includes a link to a website, such as a blog post discussing a movie, control circuitry 608 or 712 may analyze the website to identify the media asset (e.g., the movie) to which the message relates. This analysis may be performed using a computerized predictive model similar to the message analysis described above.

In some embodiments, the message may relate to two or more media assets, and control circuitry 608 or 712 may identify each of the media assets to which the message relates. In other embodiments, the message may not relate to any media assets. In such embodiments, the message may be delivered and/or displayed upon determining that the message does not relate to a media asset.

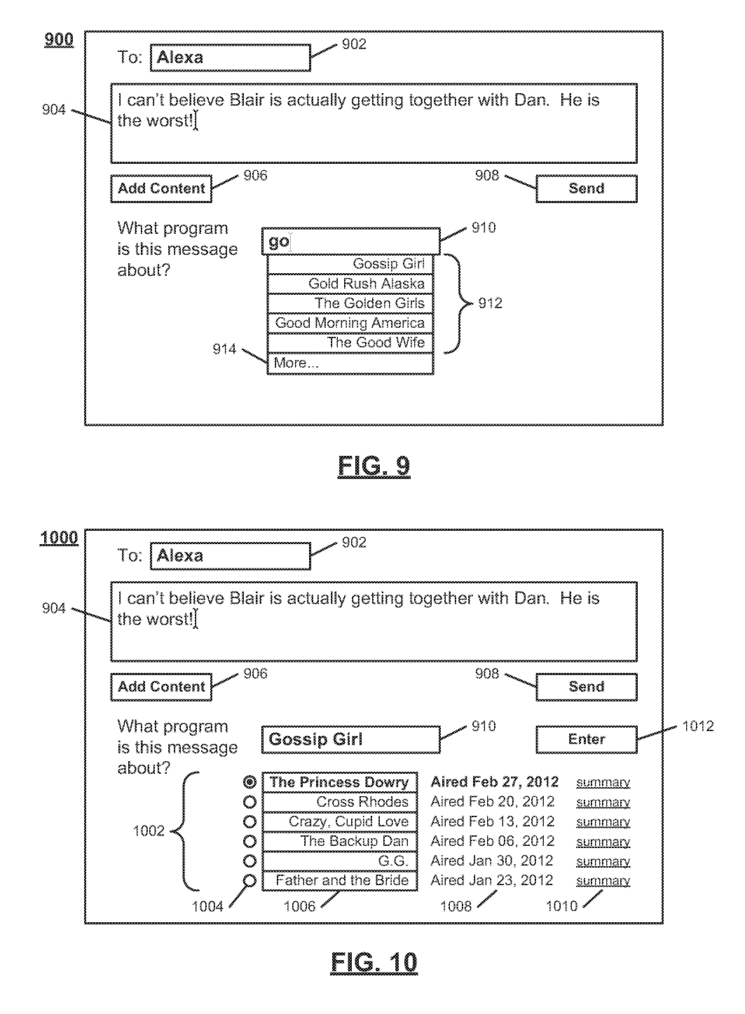

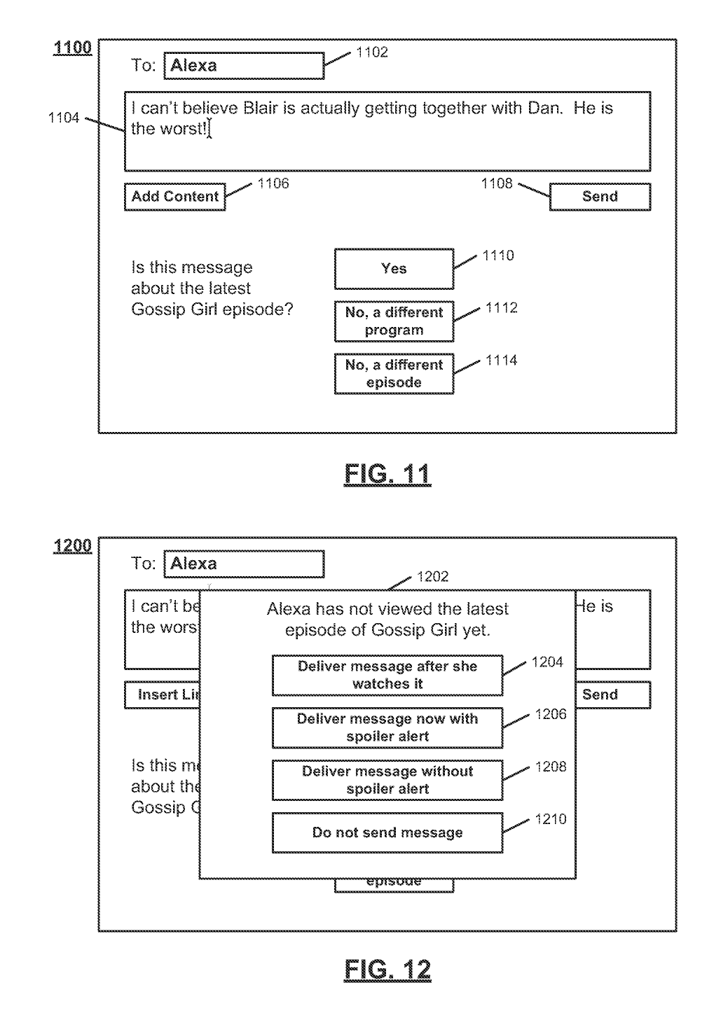

If control circuitry 608 or 712 cannot identify a media asset based on the text of the message, media asset 802, added content, or any other information, message receiving device 428 or 704 may send instructions to the user device 610 or 702 (both of which are referred to herein as the “sending user device”) to request that the sender help identify the media asset to which the message relates. FIG. 9 and FIG. 10 show display screens for receiving a message and a selection of which media asset the message is related to. FIG. 9 depicts display screen 900, which is similar to display screen 800 except that it does not include a displayed media asset. Display screen 900 includes recipient entry region 902, text entry region 904, Add Content button 906, and Send button 908, which are similar to recipient entry region 806, text entry region 808, Add Content button 810, and Send button 812 described in relation to FIG. 8.

Display screen 900 further includes text entry box 910 in which a user enters a name of the media asset. In some embodiments, text entry box 910 may not be displayed until the user selects Send button 908. In such embodiments, control circuitry 608 or 712 may try to identify the media asset discussed using the techniques described above, and if the media asset cannot be identified, the sending user device 610 or 702 asks the user which media asset the message is about and displays the text entry box 910. In other embodiments, Send button 908 does not appear until the media asset has been identified by the user.

Control circuitry 306 of the sending user device receives the text entered by the user in text entry box 910 and may send the text to messaging server 428 or another server, such as content source 416, for assisting in the identification of the media asset. Messaging server 428 may determine suggested media assets (e.g., movies) or programs that the user may be searching for and transmits data identifying these media assets or programs back to control circuitry 304. Control circuitry 304 displays the suggested media assets and/or programs as selectable suggestions 912. For example, in FIG. 9, the user has typed the string “go”. Messaging server 428 may identify the most likely programs that the user is trying to enter and transmit them to control circuitry 304 for display as suggestions 912. For example, messaging server 428 may find the most popular programs or media assets that begin with “go” or contain the string “go”, or may perform further analysis, such as correcting spelling errors or determining the most likely programs based on the user's viewing history. If the user does not see the media asset or program he is looking for in the suggestions 912, he may continue entering the string in text entry box 910 or may select “More” button 914 to view additional suggestions.

If control circuitry 304 receives a user selection of a single media asset, such as a movie, from display screen 900, data identifying selected media asset is transmitted to message receiving device 428 or 704 and the media asset identification is complete. If the user makes a selection in FIG. 9 that requires further identification (e.g., if the user selects a name of a serial television program and the episode may be identified, or if the user selects a matchup in the World Series and a particular game in the series may be identified), sending user device 610 or 702 may provide a display screen, such as display screen 1000 of FIG. 10, so that a user can more particularly identify the media asset.

Display screen 1000 includes the recipient entry region 902, text entry region 904, Add Content button 906, and Send button 908 of FIG. 9. Display screen 1000 also includes text entry box 910, in which the television program Gossip Girl has been entered. Display screen 1000 further includes a list of media assets 1002 from which the sender can select the particular media asset to which his message relates. In this example, display screen 1000 lists recent Gossip Girl episodes 1002. The media assets 1002 may be identified by title 1006 and the original air date 1008. Display screen 1000 also may include links 1010 to summaries of each media asset. If control circuitry 304 receives a user selection of a summary link 1010 or if a user positions a cursor over the summary link 1010, the display 312 may display a summary of the episode. The summary may be displayed, for example, in a separate window or as an overlay. Display screen 1000 includes radio buttons 1004 next to each of the media assets 1002 to receive a user selection of the media asset to which the message relates. In some embodiments, more than one media asset may be selected. Once the user has entered his selection, he may select the Enter button 1012. Upon receiving the Enter command from the user, control circuitry 304 of the user device sends data identifying the media asset selected by the user to message receiving device 428 or 704 and the media asset identification is complete.

In some embodiments, control circuitry 608 or 712 identifies a possible media asset to which the message relates using the techniques described in relation to FIG. 8 and seeks confirmation from the sender that message receiving device 428 or 704 has identified the correct media asset. FIG. 11 depicts a display screen 1100 for displaying a suggestion of a media asset that a message may be related to and requesting confirmation of this suggestion. Display screen 1100 includes recipient entry region 1102, text entry region 1104, Add Content button 1106, and Send button 1108, which are similar to recipient entry region 806, text entry region 808, Add Content button 810, and Send button 812 described in relation to FIG. 8.

Once the user has entered the message and the sending user device 610 or 702 has transmitted the message to message receiving device 428 or 704, control circuitry 608 or 712 identifies a likely media asset to which the message is related using the techniques described in relation to FIG. 8. If control circuitry 608 or 712 cannot identify a media asset to which the message may relate, control circuitry 608 or 712 transmits a request to the sending user device 610 or 702, causing control circuitry 304 of the sending user device 610 or 702 to display a user interface for receiving an identification of the media asset, such as the user interface shown in display screen 900. However, if control circuitry 608 or 712 identifies a potential media asset, this potential media asset may be identified to the sender using display screen 1100, and the sender may be asked whether the identified media asset is correct.

For example, in the example shown in FIG. 11, control circuitry 608 or 712 has identified that the message may relate to the most recent episode of Gossip Girl. In addition to the suggest media asset, display 312 of the sending user device also displays three buttons: Yes button 1110, Different Program button 1112, and Different Episode button 1114. If control circuitry 304 of the sending user device receives a user selection of Yes button 1110, control circuitry 304 of the sending user device sends the confirmation to message receiving device 428 or 704, and the media asset identification is complete. If control circuitry 304 of the sending user device receives a user selection of Different Program button 1112, control circuitry 304 displays an interface for receiving a user selection of a different program, such as display screen 900. If control circuitry 304 of the sending user device receives a user selection of Different Episode button 1114, control circuitry 304 displays an interface for receiving a user selection of a different episode of the same, such as display screen 1000.

Once the media asset or media assets the message relates to has been identified, control circuitry 608 or 712 may determine whether the media asset has been viewed by the message's intended recipient by cross-referencing the identified media asset or media assets with the recipient's viewing history 604 or 708. In some embodiments, if the user has multiple viewing histories (e.g., two viewing histories, each associated with a different content provider), control circuitry 608 or 712 cross-references the identified media asset(s) to each of the viewing histories. In other embodiments, control circuitry 608 or 712 combines multiple viewing histories into a single combined viewing history, and then control circuitry 608 or 712 can cross-reference the identified media assets(s) to the combined viewing history.

In the system of FIG. 6, if control circuitry 608 determines that the message recipient has viewed the media asset, message receiving device 428 sends the message to user equipment device 612. In the system of FIG. 7, the receiving user device 704 has already received the message. Having received the message and having determined that the message recipient has viewed the media asset, user equipment device 612 or 704 may display the message to the user or make the message available to the user for display, e.g., by listing the message in an inbox of the user.

If control circuitry 608 or 712 determines that the message recipient has not viewed the media asset, control circuitry 608 or 712 may send an automated response to the sending user device. In some embodiments, upon receiving the automated response from message receiving device 428 or 704 indicating that the recipient has not viewed the media asset, the sending user device provides options to the sender for whether and how to deliver the message. Exemplary options are shown in display 1200 of FIG. 12. Display 1200 may include an overlay 1202 over a messaging display, such as display 1100 of FIG. 11. Overlay 1202 may indicate that the message recipient has not viewed the identified media asset, and overlay 1202 may further present options for the user. These options may include the following: Deliver Later option 1204 (“Deliver message after she watches it”), Spoiler Alert option 1206 (“Deliver message now with spoiler alert”), No Spoiler Alert option 1208 (“Deliver message now without spoiler alert”), and Cancel option 1210 (“Do not send message”). When control circuitry 304 of the sending user device receives a user selection of any of these options, it transmits the selection to message receiving device 428 or 704, which handles the selections as follows.

If message receiving device 428 or 704 receives an indication that the sender selected Deliver Later option 1204, control circuitry 608 or 712 may monitor the recipient's viewing history to determine when the recipient has viewed the media asset to which the message relates. In the system of FIG. 6, if control circuitry 608 determines that the message recipient has viewed the media asset, message receiving device 428 sends the message to user equipment device 612; in the system of FIG. 7, the user equipment device 704 has already received the message. Having received the message and having determined that the message recipient has viewed the media asset, user equipment device 612 or 704 may display the message to the user or makes the message available to the user for display, e.g., by listing the message in an inbox of the user. In some embodiments, the sender may identify a portion of the media asset to which the message relates; in this case, control circuitry 608 or 712 may determine that the recipient has viewed the identified portion and, in response, transmit or display the message to the recipient.

If message receiving device 428 or 704 receives an indication that the sender selected Spoiler Alert option 1206, user equipment device 612 (which may first be sent the message by messaging server 428) or receiving user device 704 makes the message available to the recipient for display, e.g., by listing the message in an inbox of the recipient, and user equipment device 612 or 704 provides a spoiler alert to the recipient before displaying the message. An example of a spoiler alert is shown in FIG. 14.

If message receiving device 428 or 704 receives an indication that the sender selected No Spoiler Alert option 1208, user equipment device 612 (which may first be sent the message by messaging server 428) or receiving user device 704 displays the message to the recipient or makes the message available to the recipient for display, e.g., by listing the message in an inbox of the recipient, without including a spoiler alert. A sender may select No Spoiler Alert option 1208 if he knows that the message will not spoil the recipient's enjoyment of the media asset, if he knows that the recipient does not intend to view the media asset, or if he intends to spoil the recipient's enjoyment of the media asset.

If message receiving device 428 or 704 receives an indication that the sender selected Cancel option 1210, control circuitry 608 or 712 does not display or send the message to the recipient.

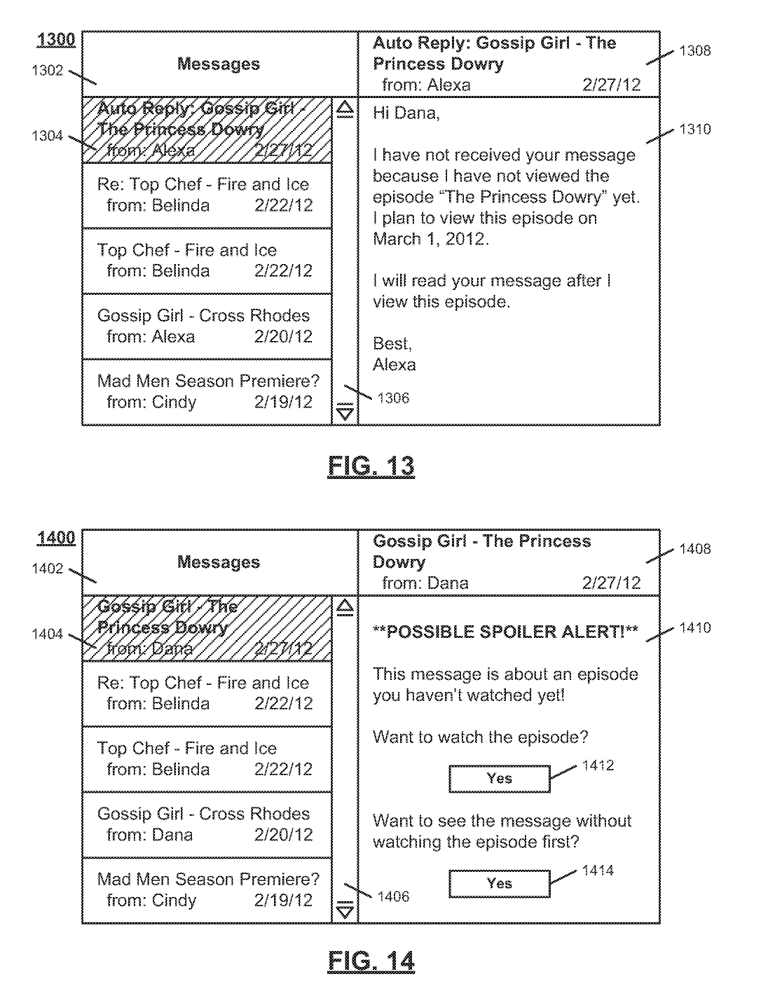

In other embodiments, if control circuitry 608 or 712 determines that the message recipient has not viewed the media asset, control circuitry 608 or 712 may automatically decline to send or display the message and may generate and send an automated response message to the sender. An example of an automated response message is shown in FIG. 13. FIG. 13 shows an illustrative message screen 1300 that displays a message that was automatically generated based on a determination by control circuitry 608 or 712 that the recipient of a received message has not viewed the media asset to which the message relates. The message screen 1300 may include a message list 1302 and a message view region 1310. The message list 1302 includes message 1304, which was generated automatically by recipient device 428 or 704. The message list 1302 may be navigable using scroll region 1306. Message 1304 is highlighted in message list 1302. Information describing the highlighted message is displayed in header region 1308, and the message is displayed in full in message view region 1310.

In some embodiments, response preferences stored on or accessed by message receiving device 428 or 704 provide rules that control circuitry 608 or 712 use for generating automatic responses. These response preferences may include, for example, a greeting to include in the automatic response (e.g., “Hello!”), a message to include in the automatic response (e.g., “Thanks for your message! I have not viewed the show you are talking about yet.”), or a closing to include in the automatic response (e.g., “Regards”). The response preferences may include instructions for the messaging receiving device 428 or 704 to insert information related to the sender (e.g., “Dear <sender name>”, where <sender name> can be the sender's full name, first name, username, etc.), information related to the media asset (e.g., “I have not yet viewed the <media asset identifier>”, where <media asset identifier> can be the media asset title and any other identifying as needed, such as episode title or number), and/or information related to the user's viewing schedule (e.g., “I plan to view this program on <date>”, where <date> identifies the date, and may identify the time, when the viewer has scheduled to watch the program in viewing schedule 550).

In some embodiments, default response preferences are stored automatically, and message receiving device 428 or 704 may receive input from the user to adjust the response preferences. In some embodiments, the user may be able to set deviations from the response preferences for particular messages, i.e., certain types of media assets, certain senders, a particular message delivery mechanism, etc.

FIG. 13 shows message 1310, which may be generated according to user selected response preferences discussed above. Message 1310 explains to the sender of the message that the message has not been delivered because its intended recipient has not yet viewed the media asset. Message 1310 also indicates that the message will be delivered and read after its recipient has viewed the media asset. Since the media asset is included in the viewing schedule 550 of the recipient, message 1310 includes an indication of when the message recipient intends to view the media asset. Message 1310 may additionally or alternatively include a time at which the media asset will be accessible by the recipient, as described in relation to FIGS. 6 and 7. Control circuitry 608 or 712 may additionally automatically generate and transmit another automated message to the sender when the recipient actually views the media asset and the message about the media asset has been delivered to the recipient. In some embodiments, the sending user device may allow the sender to override the message block or cancel sending the message as described in relation to FIG. 12.

If the sender has opted to send the message with the spoiler alert, as described in relation to FIG. 12, or if control circuitry 608 or 712 is configured to send or display messages related to unviewed content with a spoiler alert, the message may be presented to the recipient with an option to view the message, as shown by display screen 1400 of FIG. 14. The format of display screen 1400 is similar to the format of display screen 1300, except display screen 1400 is displayed on a user equipment device used by the message recipient, such as user equipment device 612 or 704. Message 1410 displayed on display screen 1400 by display 312 of the recipient's user equipment 608 or 712 clearly indicates to the viewer that the message selected in message list 1402 may contain a spoiler. Message 1410 may present a View Media Asset option 1412 that the user can select to view the media asset to which the message relates and/or View Message option 1414 that the user can select to view the message without viewing the media asset first.

If control circuitry 608 or 712 receives a user selection of View Media Asset option 1412, control circuitry 608 or 712 retrieves the media asset from, for example, media content source 416 or local storage such as storage 308, and user equipment device 612 or 704 displays the media asset to the user. After the media asset or a portion of the media asset has been displayed, or while the media asset is being displayed, the control circuitry causes the message to be displayed to the message recipient. The message may be synchronized to a particular point or portion of the media asset.

If control circuitry 608 or 712 receives a user selection of View Message option 1414, control circuitry 608 or 712 displays the message in place of message 1410. If the message recipient does not want to view the message or the media asset at this time, he may select another message to view or navigate away from messages display screen 1400. In some embodiments, message 1410 may provide an option to resend the message once the recipient has viewed the media asset and/or to send a reminder of the message once the recipient has viewed the media asset. After the recipient has viewed the message and/or the media asset, control circuitry 608 or 712 may automatically generate a message to the sender of the message informing the sender that the message or media asset has been viewed.

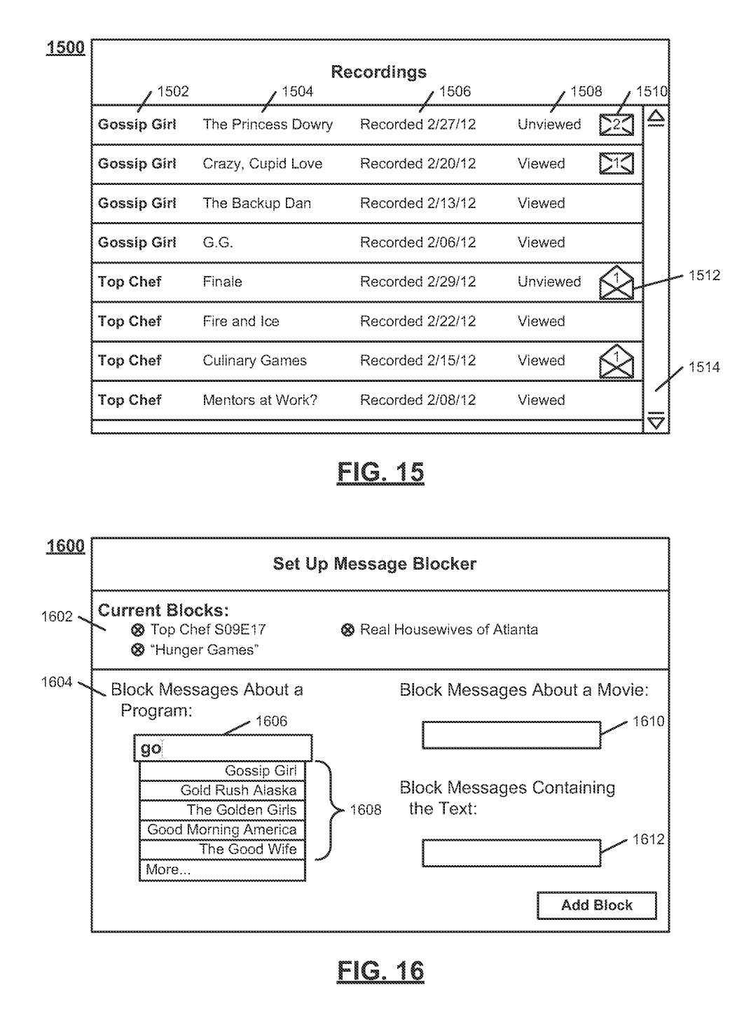

In some embodiments, message notifications can appear in other display screens of the recipient's user equipment device 608 or 712. For example, message notifications can appear within a media guidance application as a listing of messages (such as list 1402), in a listing of available programs, in a listing of bookmarked or saved programs, in a listing of scheduled programs, in a listing of recorded programs, or any other type of display within a media guidance application. As one example of message notifications, FIG. 15 shows a display screen 1500 for displaying a recorded content list identifying received messages related to the recorded content.

Display screen 1500 includes a selectable list of recorded media assets. Media assets may be identified by program title 1502, episode title 1504, and date recorded 1506, as shown in FIG. 15. Any alternative or additional information can be used to identify recorded media assets. Display screen 1500 also may include a viewed indication 1508 identifying whether each media asset has or has not been viewed. Each media asset may include messages icon 1510 or 1512 identifying whether any messages related to the media asset have been received, and whether the received messages have been read. Unread messages icon 1510 indicates that the number of messages displayed on the icon have been received and that the messages have not been read. Read messages icon indicates that the number of messages displayed on the icon has been received and that the messages have been read. In some embodiments, both icons may be displayed for a particular media asset if some but not all of the received messages relating to that media asset have been read. Display screen 1500 can be navigated using, for example, scroll region 1514.

A user can select each of the listings in display screen 1500. If control circuitry 608 or 712 receives a user selection of a recorded media asset, control circuitry 608 or 712 may display an interface, such as a new screen or an overlay, for receiving a user command. User commands may include options to view the media asset, delete the media asset, view more information about the media asset, or view messages related to the media asset. Upon receiving a user request to view messages related to the media asset, control circuitry 608 or 712 may display the messages using a display screen similar to display screen 1400. Messages icons 1510 and 1512 on display screen 1500 may also be selectable, and if selected, control circuitry 608 or 712 may display the messages using a display screen similar to display screen 1400.

In some embodiments, if the recipient has not viewed a media asset for which messages have been received, he will receive message notification 1510 indicating that messages were received, but he may not be sent the messages or he may not be permitted to read the messages until he views the media asset. As a result of seeing unread message icon 1510, which indicates that a message recipient's contacts are sending messages about a particular media asset, the message recipient may be encouraged to watch the media asset. In some embodiments, a message notification is displayed to a recipient when it is received, which may be, for example, while the recipient is watching a different program or performing another task. If control circuitry 608 or 712 receives a user selection of unread message icon 1510, control circuitry may provide an indication of the media asset being discussed or a link to the media asset. This may encourage the recipient to view the media asset immediately or sooner than he had intended to so that he can read the received message.

In some embodiments, control circuitry 608 or 712 may provide an override feature allowing a user to view the messages without viewing the media asset. If the user attempts to view a message related to a media asset that he has not viewed, control circuitry 608 or 712 may display a spoiler alert, such as the spoiler alert shown in FIG. 14.

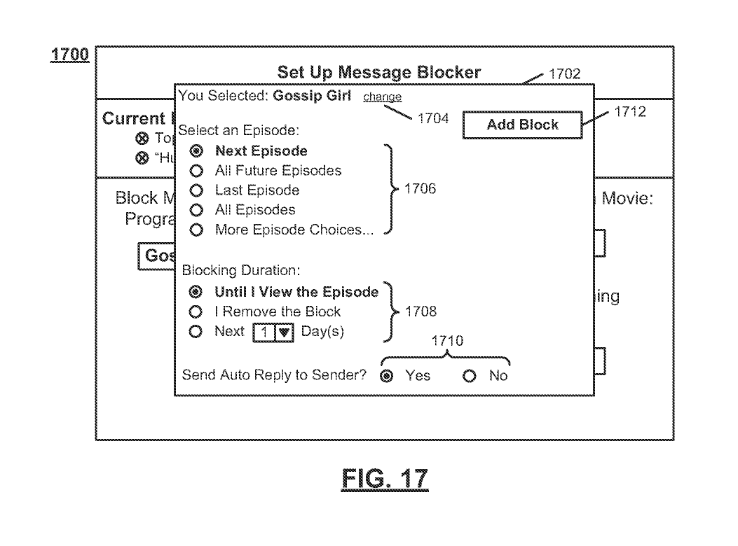

In some embodiments, in addition to blocking messages based on viewing history or rather than blocking messages based on viewing history, messaging system 600 or 700 may allow a user to set up message blocks for particular programs or movies, particular words or phrases, or other criteria. FIG. 16 depicts a Set Up Message Blocker screen 1600 with which a potential message recipient can set up message blocks. FIG. 17 shows a message blocking options overlay for providing additional message blocking options. FIGS. 16 and 17 are described in relation to systems 600 and 700 of FIGS. 6 and 7, in which user equipment device 612 or 704 may set up message blocks to block messages sent from other user devices, such as user equipment device 610 or 702.

Set Up Message Blocker screen 1600 includes a summary region 1602 which lists the blocks currently in place. In FIG. 16, the user has blocked messages relating to S09E17 of the program Top Chef, messages containing the string “Hunger Games”, and messages related to the television show Real Housewives of Atlanta. Each of the blocks may be displayed with an x next to it, as shown; if control circuitry 304 of user equipment device 612 or control circuitry 712 receives a user selection of an x, the block next to the x is removed from summary region 1602, and messages that match the block may no longer be blocked.

Message receiving device 428 or 704 may manage the blocking of messages. When message receiving device 428 or 704 receives a message, control circuitry 608 or 712 determines whether the message contains a blocked string. In the example of FIG. 16, recipient device determines whether the message contains the string “Hunger Games”. If the message contains a blocked string, control circuitry 608 or 712 automatically generates and transmits a response to the sending user device, which may display a response such as overlay 1202 with options for the sender or response message 1310.

Control circuitry 608 or 712 determines whether the message relates to any of the blocked media assets. This determination may be performed before, after, or in parallel with determining whether the message contains a blocked string. Control circuitry 608 or 712 may determine the media asset to which the message relates using any of the techniques described above, such as identifying content in the message, identifying content viewed by the sender when the message was sent, analyzing the text of the message, querying the sender, etc. If the message is related to a blocked media asset, control circuitry 608 or 712 automatically generates and transmits a response to the sending user device, which may display a response such as overlay 1202 or response message 1310. For example, in relation the example of FIG. 16, if message receiving device 428 or 704 is blocking messages according to the current blocks 1602, message receiving device 428 or 704 would block any message related to the seventeenth episode of season 9 of television program Top Chef and any message related to any episode of the Real Housewives of Atlanta, another television program.

Set Up Message Blocker screen 1600 also includes region 1604 for adding message blocks. Region 1604 may allow a user to enter the name of a program in text box 1606, the name of a movie in text box 1610, or a string in text box 1612. In the system of FIG. 6, when control circuitry 304 of user equipment device 612 receives text entered by the user in one of text box 1606, 1610, or 1612, control circuitry 304 of user equipment device 612 may transmit the text to messaging server 428. In the systems of either FIG. 6 or FIG. 7, control circuitry 304 of user equipment device 612, control circuitry 608, or control circuitry 712 may transmit the text to another server or device, such as content source 416, for assisting in the identification of a media asset or string for blocking by determining and transmitting suggestions. This suggestion generation may be similar to the selection generation described in relation to FIG. 9. Control circuitry 304 of user equipment device 612 or control circuitry 712 displays the suggested media assets, programs, or strings as selectable suggestions on user equipment device 612 or 704. For example, suggestions 1608 are suggestions for television programs beginning with the letters “go”, which the user had entered in text box 1606.

Set Up Message Blocker screen 1600 is not limited for use with programs, movies, and strings, and can alternatively or additionally be configured for receiving blocks of any other type of media content or message content. Set Up Message Blocker screen 1600 may be configured for displaying suggestions of any other type of media asset or other type of block. For example, Set Up Message Blocker screen 1600 may allow a user to block all messages from a particular contact, all messages received during a particular time of day, all messages with a particular string in the subject line, etc.

Once the user has selected a program, movie, string, or other type of block, control circuitry 304 of user equipment device 612 or control circuitry 712 may display additional blocking options and receive additional settings from the user. For example, FIG. 17 depicts message blocking options overlay 1702, which is presented as an overlay screen over Set Up Message Blocker screen 1600. Message blocking options overlay 1702 displays the selected message block along with an option 1704 to change the selected block.

Some options presented in message blocking options overlay 1702 may depend on the message block selected in Set Up Message Blocker screen 1600. These options may be determined by control circuitry 608 and transmitted to user equipment device 612 for display or may be determined and displayed by control circuitry 712. In the example in FIG. 17, the user has selected a television program, so control circuitry 304 of user equipment device 612 or control circuitry 712 displays an episode selection option 1706. If the user had selected a movie, for example, episode selection option 1706 would not be displayed.

Other options presented in message blocking options overlay 1702 may not depend on the message block selected in Set Up Message Blocker screen 1600. For example, control circuitry 304 of user equipment device 612 or control circuitry 712 may display blocking duration options 1708 and auto reply option 1710 for any block. When the user enters his preferences for the episode(s) to block, the blocking duration, and the auto reply option, he may select Add Block button 1712. Upon receiving a user selection of Add Block button 1712, control circuitry 304 of user equipment device 612 transmits the selected message block and blocking options to message receiving device (in the system of FIG. 6) and control circuitry 608 or 712 may add the block with the blocking options to a block database. The block is stored in the block database until the blocking duration has passed (e.g., until control circuitry 608 or 712 determines that the user has viewed the episode, until message receiving device 428 or 704 receives a request to remove the block, until the selected number of days has passed, or until the block has been manually removed), at which point control circuitry 608 or 712 removes the message block from the database or marks the message block as expired, so that it no longer is applied to incoming messages. The block is cross-referenced to any incoming messages, as discussed above in relation to FIG. 16, and if the auto reply option is selected, control circuitry 608 or 712 generates and transmits an automatic response to the sender. Once the message block is removed, any previously blocked messages may be transmitted, displayed, or made accessible to the recipient.

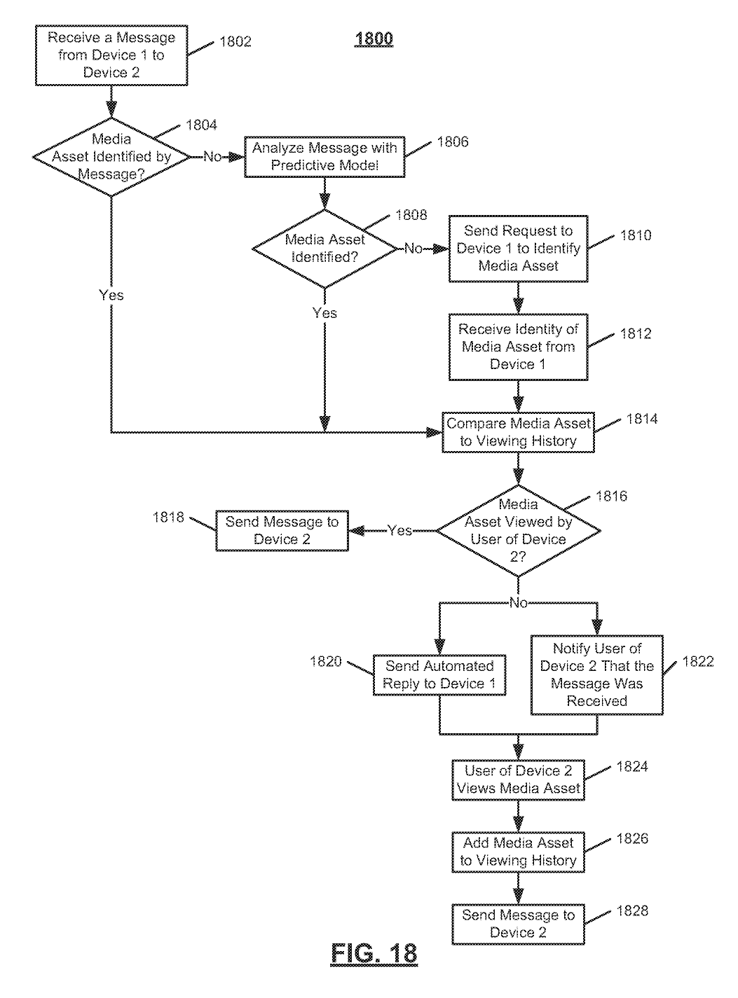

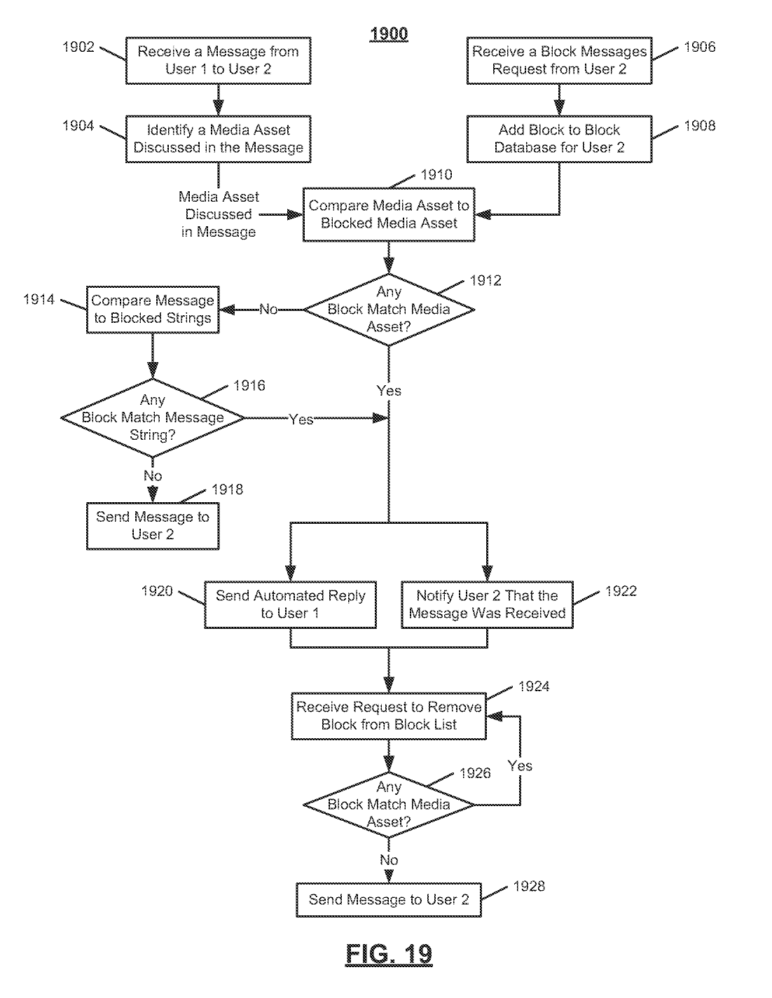

FIGS. 18 and 19 illustrate processes for generating and transmitting automatic responses that relate to unviewed media assets or that have been blocked. Applications on one or more user equipment devices 300, such as user equipment devices 610, 612, 702, and 704, and/or messaging server 428 may instruct processing circuitry to perform any of the functions described in relation to FIGS. 18 and 19.

FIG. 18 shows an illustrative process for sending an automatically generated response to a message related to content that has not been viewed by a user and sending the message to the user after he has viewed the content. The process includes steps for receiving a message, determining whether the message relates to a media asset that the message's recipient has not viewed, and sending an automatic response to the sender. The process further includes steps for blocking the message if the recipient has not viewed the identified media asset and sending the message once the recipient has viewed the media asset.

Control circuitry 608 or control circuitry 712 may receive a message transmitted from a sender's user equipment device 610 or 702 (step 1802). Control circuitry 608 or 712 determines whether the message identifies a media asset to which the message is related (decision 1804). If the message does not identify a media asset to which the message is related, control circuitry 608 or 712 may analyze the text or other content of the message using a computerized predictive model to identify a media asset to which the message is related, as discussed in relation to FIG. 8 (step 1806); control circuitry 608 or 712 may then determine whether a media asset has been identified using the computerized predictive model (decision 1808).

If the analysis did not identify a media asset to which the message is related, control circuitry 608 or 712 may send a request to the sending user device 610 or 702 to identify the media asset (step 1810). User equipment device 610 or 702 may request user input to identify the media asset, as described in relation to FIGS. 9 though 11. Control circuitry 608 or 712 receives the identity of the media asset from user equipment device 610 or 702 (step 1812).

Once a media asset has been identified by the message, a predictive model, and/or input from the sending user, control circuitry 608 or control circuitry 712 may then compare the identity of the media asset to which the message relates to the intended recipient's viewing history (step 1814), as discussed in relation to FIGS. 6, 7, and 11, to determine whether the identified media asset has been viewed by the recipient, i.e., whether the identified media asset is in the recipient's viewing history (decision 1816).

If the recipient has viewed the identified media asset, messaging server 428 in the system of FIG. 6 may send the message to the user equipment device 612 (step 1818). In either system 600 or 700, control circuitry 608 or 712 may make the message accessible to the recipient user, and may display the message or a notification about the message using display 312 of user equipment device 612 or 704.

If control circuitry 608 or 712 determines that the recipient has not viewed the media asset, control circuitry 608 or 712 generates and sends an automated response to the sending user, as described in relation to FIG. 12 or 13 (step 1820). Control circuitry 608 or 712 may also notify the user of user equipment device 612 or 704 that a message to that user was received by message receiving device 428 or 704 (step 1822), as described in relation to FIG. 14 or 15.

The user may view the media asset on user equipment device 612 or 704 (step 1824), and control circuitry 608 or 712 may receive a notification that the user has viewed the media asset. Control circuitry 608 or 712 may then add the media asset to the user's viewing history 604 or 708 (step 1826), or may transmit information identifying the media asset to an externally stored viewing history. Control circuitry 608 or 712 may monitor the user's viewing history, and when control circuitry 608 or 712 determines that the user has viewed the media asset, control circuitry 608 or 712 may send or display the message to the user (step 1828). In the system of FIG. 6, if control circuitry 608 determines that the message recipient has viewed the media asset, messaging server 428 sends the message to user equipment device 612; in the system of FIG. 7, the user equipment device 704 has already received the message. User equipment device 612 or 704 then displays the message to the user or makes the message available to the user for display, e.g., by listing the message in an inbox of the user.

FIG. 19 shows an illustrative process for setting up blocking criteria, blocking a message, sending an automatic response to a blocked message, and sending the message after it has been unblocked. Step 1902 is similar to step 1802 described above: control circuitry 608 or control circuitry 712 receives a message transmitted from a sender's user equipment device 610 or 702 (step 1902). Step 1904 is similar to steps 1804 through 1812 described above: control circuitry 608 or control circuitry 712 identifies a media asset discussed in the message by, for example, identifying a media asset that is identified by the message, discussed in the message, or that the user identifies is discussed in the message (step 1904).

Control circuitry 608 or 712 also store message blocks based on user input. Control circuitry 608 and 712 receive a request to block messages based on user input, as discussed in relation to FIGS. 16 and 17 (step 1906). Message receiving device 428 or 704 may maintain a database of message blocks, and control circuitry 608 or 712 may add the received message block to the database (step 1908). The block may be referenced by a block identifier, which may be a unique identifier for a particular media asset. Steps 1906 and 1908 may be performed before or in parallel with steps 1902 and 1904.

After message receiving device 428 or 704 has identified the media asset discussed in a particular message, control circuitry 608 or 712 may compare the media asset to the blocked media assets in the database of message blocks (step 1910) and may determine whether the message discusses a media asset for which the recipient has requested related messages be blocked, i.e., whether any of the blocks in the block database match the identified media asset (decision 1912).

In some embodiments, if the message does not relate to a media asset about which messages are to be blocked, control circuitry 608 or 712 may then compare additional elements of the message, e.g., the text of the message, to other types of message blocks, e.g., blocked string (step 1914) to determine whether any of the blocks match a string in the message (decision 1916). If the message neither relates to a media asset about which messages are to be blocked nor includes a blocked string, control circuitry 608 or 712 may send, make accessible, or display the message to the user (step 1918).

In the system of FIG. 6, if control circuitry 608 determines that the message recipient has viewed the media asset or that a string in the message matches a blocked string, messaging server 428 sends the message to user equipment device 612 (step 1920); in the system of FIG. 7, the user equipment device 704 has already received the message. Having received an unblocked message, user equipment device 612 or 704 may display the message to the user or make the message available to the user for display, for example, by listing the message in a user's message inbox. In some embodiments, the identified media asset is also compared to the viewing history, as described in relation to FIG. 18, before the message is displayed to the recipient.

If the message relates to a media asset about which messages are to be blocked or contains a blocked string, control circuitry 608 or 712 also generates and sends an automated response to the sending user (step 1922). The automated response may be similar to the automated responses described in relation to FIG. 12 or 13, but the automated response may identify that the message has been blocked rather than that the media asset has not been viewed by the recipient. Control circuitry 608 or 712 may also notify the user of user equipment device that a message to that user was received by message receiving device 428 or 704 (step 1922) but blocked; this notification may be similar to the notifications described in relation to FIG. 14 or 15.

Control circuitry 608 or 712 may receive a request to remove the block from the block list (step 1924), as described in relation to FIG. 16. Alternatively, control circuitry 608 or 712 may determine that the block has expired, according to rules for removing a block described in relation to FIG. 17. Even if one block that blocked a given message has been removed, a second block that is still in place may still block the message. For example, if a message relates two media assets, and the block on one of the media assets is removed because the user watches the media asset, the message may continue to be blocked because the block for the second media asset is still in place. So, control circuitry 608 or 712 determines whether any remaining block matches the media asset, or a string in the message, or any other message block criteria (decision 1926). If control circuitry 608 or 712 has determined that the message should no longer be blocked, the message may be sent, made accessible, or displayed to the user as in step 1914 (step 1928). If control circuitry 608 or 712 has determined that the message should still be blocked, control circuitry 608 or 712 continues to monitor changes in the block list to determine whether the message may be delivered.

It should be understood that the above steps of the flow diagrams of FIGS. 18 and 19 may be executed or performed in any order or sequence not limited to the order and sequence shown and described in the figures. Also, some of the above steps of the flow diagrams of FIGS. 18 and 19 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for automatically generating a response to a received message related to unviewed content, the method comprising:
accessing a viewing history identifying media assets that have been previously viewed by a user,
receiving, by communications circuitry, a message from a sender to be delivered to the user, wherein the message is related to a media asset;
identifying, by control circuitry, the media asset to which the received message is related;
cross-referencing, by control circuitry, the identity of the media asset with the viewing history to determine whether the user has viewed the media asset; and
in response to determining that the user has not viewed the media asset:
refraining from displaying the message to the user; and
automatically generating a response to the sender of the message indicating that the user has not seen the media asset.

2. The method of claim 1, the method further comprising:
determining when the user has viewed the media asset; and
in response to determining that the user has viewed the media asset, causing the message to be displayed to the user.

3. The method of claim 1, the method further comprising:
determining that the user has viewed the media asset to which the message relates; and
in response to determining that the user has viewed the media asset, indicating to the sender of the message that the user has viewed the media asset.

4. The method of claim 1, the method further comprising:
receiving a second message from the sender to be delivered to the user, wherein the message is related to the media asset;
determining that the response has been sent to the sender of the message; and
in response to determining that the response has been sent to the sender of the message, not sending a second response to the sender of a message.

5. The method of claim 1, wherein the media asset is not available to the user and the response identifies when the media asset will be made available to the viewer.

6. The method of claim 1, wherein the user has scheduled to view the media asset at a particular time and the response identifies the time at which the user has scheduled to view media asset.

7. The method of claim 1, the method further comprising:
notifying the user that a message has been blocked.

8. The method of claim 7, wherein the notifying further comprises indicating at least one of a number of blocked messages that relate to the media asset and the sender of the message that has been blocked.

9. The method of claim 1, the method further comprising:
receiving a command from the user to display the message; and
in response to receiving the command, causing the message to be displayed to the user before the user has viewed the media asset.

10. The method of claim 9, the method further comprising:
automatically sending a notification to the sender of the message indicating that the message has been displayed to the user.

11. A system for automatically generating a response to a received message related to unviewed content, the system comprising:
communications circuitry configured to:
receive a message from a sender to be delivered to the user, wherein the message is related to a media asset; and
control circuitry in communication with the communications circuitry, the control circuitry configured to:
maintain a viewing history identifying media assets that have been previously viewed by a user;
identify the media asset to which the received message is related;
cross-reference the identity of the media asset with the viewing history to determine whether the user has viewed the media asset; and
in response to determining that the user has not viewed the media asset:
refrain from displaying the message to the user, and
automatically generate a response to the sender of the message indicating that the user has not seen the media asset.

12. The system of claim 11, wherein the control circuitry is further configured to:
determine when the user has viewed the media asset; and
in response to determining that the user has viewed the media asset, cause the message to be displayed to the user.

13. The system of claim 11, wherein the control circuitry is further configured to:
determine that the user has viewed the media asset to which the message relates; and
in response to determining that the user has viewed the media asset, indicate to the sender of the message that the user has viewed the media asset.

14. The system of claim 11, wherein:
the communications circuitry is further configured to receive a second message from the sender to be delivered to the user, wherein the message is related to the media asset; and
the control circuitry is further configured to:
determine that the response has been sent to the sender of the message; and
in response to determining that the response has been sent to the sender of the message, refrain from sending a second response to the sender of a message.

15. The system of claim 11, wherein the media asset is not available to the user and the response identifies when the media asset will be made available to the viewer.

16. The system of claim 11, wherein the user has scheduled to view the media asset at a particular time and the response identifies the time at which the user has scheduled to view media asset.

17. The system of claim 11, wherein the control circuitry is further configured to notify the user that a message has been blocked.

18. The system of claim 17, wherein the control circuitry is further configured to indicate in the notification at least one of a number of blocked messages that relate to the media asset and the sender of the message that has been blocked.

19. The system of claim 11, wherein
the communications circuitry is further configured to receive a command from the user to display the message; and
the control circuitry is further configured to cause the message to be displayed to the user before the user has viewed the media asset in response to receiving the command.

20. The system of claim 19, wherein the control circuitry is further configured to automatically generate a notification to the sender of the message indicating that the message has been displayed to the user.

21-30. (canceled)
